(19) United States
(12) Patent Application Publication
(10) Pub. No.: US 2016/0055278 A1
(43) Pub. Date: Feb. 25, 2016

(54) Method and Device for the Co-Simulation of Two Subsystems

(71) Applicant: KOMPETENZZENTRUM - DAS VIRTUELLE FAHRZEUG FORSCHUNGSGESELLSCHAFT MBH, Graz (AT)

(72) Inventors: JOSEF ZEHETNER, ST. RADEGUND BEI GRAZ (AT); MICHAEL PAULWEBER, HAUSMANNSTÄTTEN (AT); HELMUT KOKAL, GRAZ (AT); MARTIN BENEDIKT, FROHNLEITEN (AT)

(73) Assignee: Kompetenzzentrum - Das Virtuelle Fahrzeug Forschungsgesellschaft mbH, Graz (AT)

(21) Appl. No.: 14/784,302

(22) PCT Filed: Apr. 9, 2014
(86) PCT No.: PCT/EP2014/057194

§ 371 Date: Oct. 14, 2015

(30) Foreign Application Priority Data
Apr. 15, 2013 (AT) A 50260/2013

(51) Int. Cl. G06F 17/50; G06F 17/10

(52) U.S. Cl. CPC G06F 17/5009; G06F 17/10

(57) ABSTRACT

So as to make the co-simulation of subsystems of an overall system (1), which are reciprocally coupled by way of coupling variables (y₁, y₂), real-time capable, a mathematical model (M) of the subsystems (TS1, TS2) which is valid at the current operating point of the overall system (1) is ascertained from input variables (x₁, x₂) and/or measured variables (w₁, w₂) of the subsystems (TS1, TS2) based on a method of data-based model identification and, from this model (M), the coupling variables (y₁, y₂) are extrapolated for a subsequent coupling time step and made available to the subsystems (TS1, TS2).

The invention relates to a method and to a simulation device for the co-simulation of two subsystems of an overall system, which are reciprocally coupled by coupling variables.

To simulate an overall system, the overall system is often divided into subsystems, which are then individually simulated—this is then referred to as distributed simulation or co-simulation. This is done, for example, when the subsystems are simulated in different simulation tools, or when parallel computing on multiple kernels is strived for, or when a real-time simulation (for example, a hardware-in-the-loop (HiL) system) is to be connected to a real automation system for a test bench. A subsystem represents a submodel of the system to be simulated, including the associated numerical solving algorithm. The simulations of the subsystems, when linked to each other, then yield the simulation of the overall system. In the simulation, a certain operating point of the overall system is simulated, or operating points of the subsystems related thereto are simulated, in every simulation step. An operating point describes the behavior of the overall system at a particular point in time here. In the distributed simulation of an overall system, so called coupling variables are exchanged between the subsystems at certain, predefined points in time, and the subsystems are solved in defined time steps, referred to as coupling time steps, independently of other subsystems. At the end of a coupling time step, data is exchanged between the subsystems to synchronize to the subsystems.

In the case of reciprocal dependencies of subsystems, for example when a first subsystem requires an output of a second subsystem as the input, whereby the second subsystem requires an output of the first subsystem as the input, not all coupling variables needed are known at the beginning of the coupling time step and must be estimated by way of extrapolation. The temporal behavior of one or more systems (subsystems) is predicted by way of the extrapolation.

The coupling of submodels of the subsystems is typically carried out in co-simulation based on signal-based, polynomial extrapolation of the coupling variables. In general, zero order methods, and on rare occasions methods of a higher order (1st or 2nd), are used for this purpose. The output signal y is calculated based on the signal-based extrapolation as a function of the input signal x, which is to say y=f(x)—this is also referred to as a single-input, single-output (SISO) process. Extrapolating relevant coupling variables introduces what is known as a coupling error, which directly (negatively) impacts the quality of the results of the (co-)simulation. Since an extrapolation is carried out over coupling time steps, the introduced error corresponds to a “local discretization error.” Discontinuities at the coupling points in time (due to incremental extrapolation) thus also negatively impact the numerical solution of the subsystems. To keep the coupling error small, sampling steps or exchange intervals must be kept small, which results in high computing times and consequently is not desirable. However, the coupling error also causes a distortion of the coupling signal and results in an intrinsic time lag of the coupling signal (virtual dead time), which negatively influences the dynamic behavior of closed-loop systems (such as a control loop). However, the exchange of the coupling variables also results in additional, “real” dead times through the use of communication systems, for example, the exchange of data via bus systems such as FlexRay or CAN. These real dead times are typically considerably higher than the virtual dead times resulting from coupling.

EP 2 442 248 A1, for example, describes a signal-based coupling method for a co-simulation with error correction and coupling time step control. This allows the extrapolation errors to be considerably reduced by way of an error compensation method. Furthermore, (virtual and real) dead times which do not significantly exceed the coupling time step can thus be compensated for.

The problem with signal-based extrapolation methods is that they fail when the extrapolation is carried out over long time intervals, which is to say over multiple coupling time steps. This case occurs with real-time simulation of the overall system since typically large dead times (multiple coupling time steps) occur in this case due to measurement (ND conversion), signal processing, data transmission via communication media and so forth. In the real-time simulation, the coupling variables must be available at fixedly predefined points in time (coupling time step) since otherwise the real-time simulation aborts with an error. A real-time simulation is needed, for example, when at least one real-time system is coupled (with another real-time system or a non-real-time system), or when tasks are coupled on a real-time system.

It is therefore the object of the present invention to improve the extrapolation of coupling variables in co-simulation, in particular in such a way that an extrapolation is also made possible over long time intervals, which is to say also over multiple coupling time steps, so that real-time co-simulation also becomes possible.

This object is achieved by a method, and an associated simulation device, in which a mathematical model of the subsystems which is valid at the current operating point of the overall system is ascertained from input variables and/or measured variables of the subsystems based on a method of data-based model identification, and the coupling variables for a subsequent coupling time step are extrapolated from this model and made available to the subsystems. Since the time behavior of the subsystems for a certain time period (operating point) is known very well due to the model, extrapolation is thus also possible over multiple coupling time steps, which enables real-time co-simulation. However, this also allows real-time systems to continue to be operated error-free, even in the absence of measured values over multiple coupling time steps, since these can be reliably determined by the model-based extrapolation. In addition, the model-based extrapolation also allows noisy signals to be processed.

The real and the virtual dead time can very easily be compensated for by calculating coupling variables that lie further ahead in the future by the dead time from the model by way of the extrapolation.

Error diagnosis is important, notably in real-time systems, to be able to bring the real-time system in a safe state, if needed. This is made possible when a coupling error is ascertained in the extrapolation, and method steps for treating the coupling error are initiated in dependence thereof.

The accuracy of the determination of the coupling variables can be improved when, in addition, methods for error compensation are used in the extrapolation.

In particular at the beginning of the simulation, it is possible that no sufficiently accurate model is yet available. This time period can be easily bridged by way of signal-based coupling to ascertain the coupling variables.

The accuracy of the extrapolation can be increased when a real-time bus system is used between a subsystem and the extrapolation unit, since the communication dead time can be accurately ascertained and consequently be compensated for more purposefully.

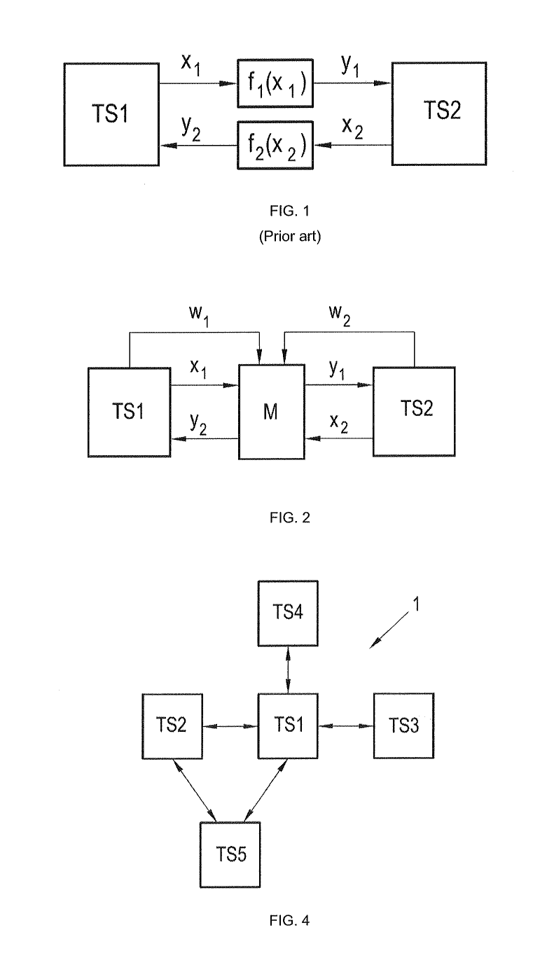

The present invention will be described in more detail hereafter with reference to FIGS. 1 to 5, which show advantageous embodiments of the invention by way of example and in a schematic and non-limiting manner. In the drawings:

FIG. 1 shows a signal-based extrapolation of the coupling variables according to the prior art;

FIG. 2 shows the model-based extrapolation of the coupling variables according to the invention;

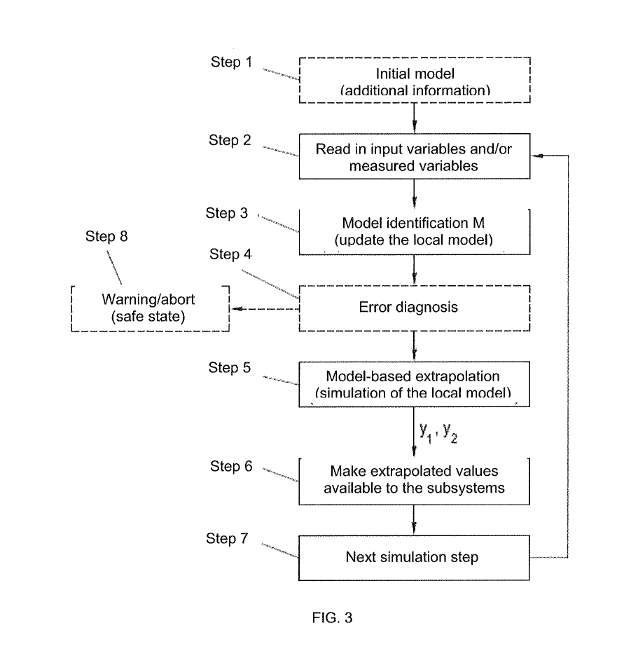

FIG. 3 shows an exemplary flow chart of a method for extrapolating the coupling variables;

FIG. 4 shows an example of the co-simulation of an overall system; and

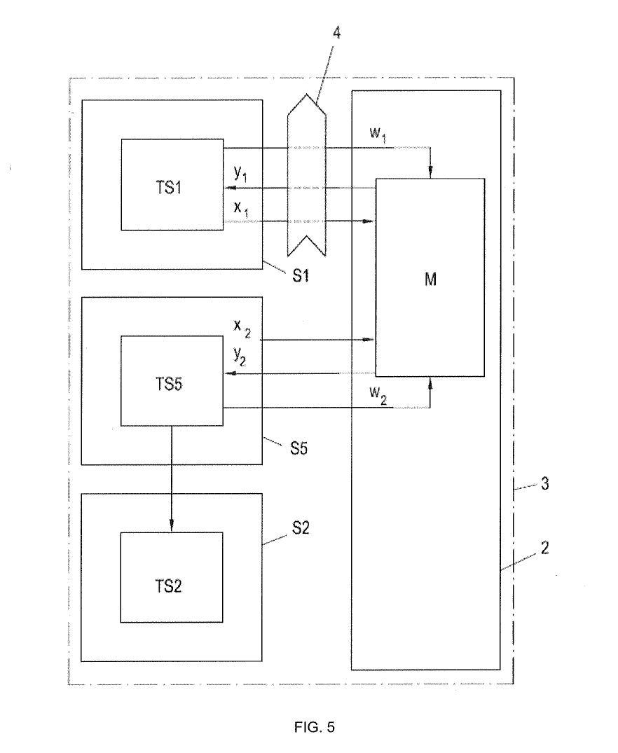

FIG. 5 shows a simulation device for implementing the method for extrapolating the coupling variables.

For explanation, FIG. 1 shows the signal-based approach to extrapolation of the coupling variables according to the prior art. Two subsystems TS1, TS2 are reciprocally coupled. The functions f₁, f₂ extrapolate the coupling variables y₁, y₂ from the input variables x₁, x₂ by way of polynomial extrapolation, such as zero order hold (ZOH), first order hold (FOH) or second order hold (SOH), which is to say y₁=f₁(x₁(t), t), y₂=f₂(x₂(t),t).

The following exemplary embodiment mentions two input, coupling and measured variables, respectively; however, the invention of course also covers any arbitrary other number of such variables.

According to the invention, a model-based approach is now chosen, in which a mathematical model M of the subsystems TS1, TS2 is used to extrapolate the coupling variables y₁, y₂, as shown schematically in FIG. 2. The model M is ascertained from the input variables x₁, x₂ and/or from measured variables w₁, w₂, taking both the current and past time values into consideration. Input variables are generally understood to mean variables that, for example, can also correspond to data exchanged between simulation models. Measured variables can originate from sensors of any arbitrary type, for example, and signal noise may accordingly be present.

From the model M, y₁=f₁(x₁(t), x₂(t), y₂=f₂(x₁(t), x₂(t), t) follows for the coupling variables. When using only measured variables, y₁=f₁(w₁(t), w₂(t), t), y₂=f₂(w₁(t), w₂(t), t) follows for the coupling variables from the model M in the exemplary embodiment shown. When input and measured variables are used according to the above-described definition, y₁=f₁(x₁(t), x₂(t), w₁(t), w₂(t), y₂=f₂(x₁(t), x₂(t), w₁(t), w₂(t), t) follows for the coupling variables from the model M.

Thus, a multiple-input, multiple-output (MIMO) system is present. Model M includes an identified model of the subsystems TS1, TS2 which is valid only locally, which is to say short-term for the current operating point of the overall system. By this model-based extrapolation the extrapolation is adaptively adapted to the system behavior or the system solution. However, the model-based extrapolation also allows noisy signals (coupling variables y₁, y₂, input variables x₁, x₂, measured variables w₁, w₂) to be processed since the extrapolation is carried out based on a model M, and is not based on the noisy measured variables themselves, which is not possible with signal-based extrapolation.

Sufficiently known methods of data-based model identification are resorted to for determining the model M. The model is ascertained from current and past input variables x₁, x₂ and/or measured values w₁, w₂ of the subsystems TS1, TS2. Such methods include, for example, recursive least squares methods (RLS, R Extended LS), (extended) Kalman filter methods, recursive instrumental variable methods, recursive subspace identification, projection algorithms, stochastic gradient algorithms, recursive pseudo-linear regressions, recursive prediction error methods, observer-based identification methods (sliding mode, unknown input observer, and the like), Fourier analysis, and correlation analysis. Such methods are used to determine and continuously optimize the parameters of the model M based on the current operating point of the overall system. The model structure can be arbitrarily predefined for this purpose, such as a second-order linear, time-invariant system, having two inputs and outputs. The measured variables w₁, w₂ used are advantageously measured variables w₁, w₂ offered by the subsystems, wherein current and past measured variables w₁, w₂ may be used.

An initial model may also be ascertained or predefined in advance at the beginning of the simulation using known quantities or external knowledge. So as to ascertain the initial model parameters, it is possible, for example, to backward calculate internal starting states for the subsystems and for the estimated model by way of inverse models, or to calculate the internal model states by way of a simpler method, until the model-based method has reached steady state, or it is possible to set correct starting values for the input signals. However, in principle, any arbitrary initial model may be used. It is also conceivable to provide signal-based coupling until the estimated model is available or valid.

Since the time behavior of the subsystems TS1 and TS2 for a certain time period (operating point) is known very well due to the model M, potential dead times can also be compensated for. In this way, the behavior of the respective other subsystem TS1, TS2 can be predicted without having to wait for the dynamic response of the system.

By using a model M to determine the coupling variables y₁, y₂, it is possible to continue to operate (at least temporarily) a real-time system error-free even in the case of absent measured variables w₁, w₂ over multiple coupling time steps, since these can be reliably determined by way of the model-based extrapolation.

The co-simulation of two subsystems TS1, TS2 can then take place as shown in FIG. 3. In a first step according to the described exemplary embodiment, an initial model is predefined or ascertained. This is an optional step. Thereafter, in a second step, the required measured variables w₁, w₂ and/or input variables x₁, x₂ are read in and based thereon, and in a third step, the locally, which is to say within the simulation step, valid parameters of the model M are determined by way of a data-based method of model identification. The parameters can also remain valid over multiple simulation steps, for example when it is not possible for some reason to read in any new measured variables w₁, w₂ and/or input variables x₁, x₂. Steps 2 and 3 would accordingly be eliminated.

Optionally, it is also possible to ascertain the coupling error, for example an extrapolation error, a dead time, absence of data, and so forth (step 4) and, based thereon, method steps may be initiated, such as aborting the simulation, switching the system to a safe state, or outputting a warning (step 8).

The model-based extrapolation allows the real and virtual dead times that occur in the closed system to be compensated for. The real dead time, caused by the communication or the signal exchange, such as via a bus system, but also by computing times, or times for measuring and processing the signals, can be compensated for by using the model M to estimate further ahead into the future. Through the use of real-time bus systems 4 (indicated in FIG. 5), which is to say time-triggered bus systems, or, generally speaking, systems that transmit time information in addition to the signal, the accuracy of the extrapolation can be increased since it is possible to exactly ascertain the communication dead time, such as by estimating the dead time based on the information from the real-time bus system 4 or by evaluating the estimated model. The virtual dead time, caused by time delays as a result of the sampling, can be implicitly compensated for through the use of the model-based extrapolation. The model-based extrapolation according to the invention can thus be used to compensate for all dead times, which results in a considerable improvement of the simulation behavior, notably when using real-time systems.

Based on the local model M, the coupling variables y₁, y₂ are calculated in a fifth step, which are then made available in a sixth step to the subsystems TS1, TS2 for the co-simulation in the next simulation step, whereby the method continues again with the second step. However, the coupling variables y₁, y₂ can also be further processed otherwise in the subsystems TS1, TS2, for example when a subsystem TS1, TS2 is not being simulated, but is really rigged up.

It is also possible to employ methods for additional error compensation in the ascertainment of the coupling variables y₁, y₂, such as a method as described in EP 2 442 248 A1. This would allow the accuracy of the ascertained coupling variables y₁, y₂ to be increased even further.

FIG. 4 shows a schematic illustration of the co-simulation of an overall system 1 using the example of a hybrid vehicle. The subsystem TS1 represents an electric machine, for example, the subsystem TS2 an internal combustion engine, the subsystem TS3 a drive train, the subsystem TS4 an electrical energy storage, and the subsystem TS5 a hybrid control unit. The connections between these describe the connections between the subsystems TS. The hybrid control unit may be present in real, for example, in HiL hardware, and the other subsystems TS1 through TS4 run as simulations on appropriate simulation platforms, such as dSpace or Matlab, whereby real-time co-simulation becomes necessary. However, it is also possible to additionally configure other subsystems as real hardware, for example the internal combustion engine on an engine test stand.

FIG. 5 shows the simulation device 3 for a portion of the co-simulation of the overall system 1 by way of example. Each subsystem TSn is simulated in a dedicated simulation environment (hardware and with software for simulating the submodel of the subsystem using the intended solving algorithm) Sn. It is also possible, of course, to simulate multiple or all subsystems in one simulation environment. The simulation environment S5 is an HiL system, for example, comprising the corresponding hardware and software. The simulation environments S1 and S2 are realized on suitable computers, for example, with appropriate software, such as Simulink made by Mathworks or Adams made by MSC. The subsystems TS1 and TS5 are reciprocally dependent on each other, so that the dependency for the co-simulation must be resolved by way of the coupling variables y₁, y₂ as described above. An extrapolation unit 2 is provided for this purpose, which is implemented, for example, as computer hardware with appropriate software and the necessary algorithms, such as for the model identification. The extrapolation unit 2 receives the input variables x₁, x₂ and measured variable w₁, w₂ from the subsystems TS1, TS5 and, based thereon, identifies a locally valid model M for each simulation step. At the same time, the coupling variables y₁, y₂ are then calculated from the model M and made available to the subsystems TS1, TS5.

1. A method for co-simulating two subsystems (TS1, TS2) of an overall system (1), which are reciprocally coupled by way of coupling variables (y₁, y₂), characterized in that a mathematical model (M) of the subsystems (TS1, TS2) which is valid at the current operating point of the overall system (1) is ascertained from input variables (x₁, x₂) and/or measured variables (w₁, w₂) of the subsystems (TS1, TS2) with on a method of data-based model identification and, from this model (M), the coupling variables (y₁, y₂) are extrapolated for a subsequent coupling time step and made available to the subsystems (TS1, TS2).

2. The method according to claim 1, characterized in that the real and the virtual dead time is compensated for by calculating coupling variables (y₁, y₂) that lie further ahead in the future by the dead time from the model (M) by way of the extrapolation.

3. The method according to claim 1, characterized in that a coupling error is ascertained in the extrapolation, and method steps for treating the coupling error are initiated in dependency thereof.

4. The method according to claim 1, characterized in that methods for error compensation are used in the extrapolation.

5. The method according to claim 1, characterized in that signal-based coupling is used to ascertain the coupling variables (y₁, y₂) until the identified model (M) is available.

6. A simulation device for the co-simulation of at least two subsystems (TS1, TS2) of an overall system (1), which are reciprocally coupled by way of coupling variables (y₁, y₂), characterized in that at least one extrapolation unit (2) is provided, which receives input variables (x₁, x₂) and/or measured variables (w₁, w₂) of the subsystems (TS1, TS2) and, based thereon, identifies a mathematical model (M) of the subsystems which is valid at the current operating point of the overall system (1) based on a method of data-based model identification in order to calculate the coupling variables using the model (M).

7. The simulation device according to claim 6, characterized in that at least one subsystem (TS1, TS2) and at least one extrapolation unit (2) are connected by at least one real-time bus system (4).
